(19) United States
(12) Patent Application Publication
(10) Pub. No.: US 2005/0180317 A1
(43) Pub. Date: Aug. 18, 2005

(54) Server backup device

(76) Inventor: Yoshinori Shimada, Kawasaki (JP)

Correspondence Address: KATTEN MUCHIN ROSENMAN LLP, 575 MADISON AVENUE, NEW YORK, NY, 10022-2585, US

(21) Appl. No.: 10/886,360

(22) Filed: Jul. 7, 2004

(30) Foreign Application Priority Data
Feb. 12, 2004 (JP) 2004-035014

(51) Int. Cl. H04L 12/26; H04L 12/66

(52) U.S. Cl. 370/217; 370/352; 370/260

(57) ABSTRACT

A server backup device comprises a unit detecting the failure of an IP Centrex server and a unit rewriting a destination address in a prescribed message transmitted from a terminal for intra-office communication between terminals on a network during the failure from the address of the server backup device to the address of a called terminal and directly transferring the message to the called terminal without going through the IP Centrex server.

### BACKGROUND OF THE INVENTION

1. Field of the Invention

The present invention relates to a wired telephone system, and more particularly to a backup device used when a Centrex server for providing an IP audio telephone signal with the conventional PBX functions and the like fails.

2. Description of the Related Art

Recently, IP Centrex servers for incorporating/providing both an Internet service function of LAN systems and an audio switching service function, such as a conventional PBX and the like have been widely used.

In such a system, all telephone terminals under a Centrex server must always access the server when originating a call. Therefore, if the Centrex server or a communication line up to the Centrex server fails, the server cannot be normally accessed, and for all the IP telephone terminals under the server, a telephone service between terminals in a service area corresponding to the coverage of the conventional PBX cannot be used, which is a problem.

In such a case, there is a terminal that can detect, for example, the disconnection of an LAN cable and can cope with it. Such a terminal has a function to attempt to establish a connection to PSTN (Public Switched Telephone Network, that is, a public telephone network) when a user attempts to use a telephone service in the case the access to the IP Centrex server cannot be made. Therefore, the user can originate a call using the PSTN at the time of emergency. However, in order to enable communication in the service area, a plurality of telephone lines are needed for one service area. Furthermore, an extra telephone fee is charged by using the PSTN for intra-office communication, which is normally free of charge, which is another problem.

Furthermore, there is a telephone terminal that when detecting that it cannot access the IP Centrex server, it can attempt to use a special router, and this special router can attempt to access the Centrex server using another route. Even when a route to the Centrex server fails, a user can use an IP telephone service by using such a terminal.

In this case, the special router can recognize the relevant call from the IP telephone terminal, as an intra-office call or as an incoming call from the outside. If the call is an intra-office call, the router works in place of the IP Centrex server to enable intra-office communication. However, in order to use this function, the IP telephone terminal must detect that it cannot access the IP Centrex server. The number of equipment with such a function is actually fairly limited, and a terminal without such a function cannot use a telephone service when the IP Centrex server fails, which is another problem.

As the prior art for coping with a failure, such as a power failure in such a telephone system, there is the following document.

Japanese Patent Laid-off Publication No. 2002-152250 “Audio Switching System”

This document discloses an audio switching system for providing an IP audio signal with both the services of a key telephone, a PBX, a Centrex and the like, and Internet access. The audio switching system comprises a line card with a switching/connection function to continuously supply power from a backup power supply at the time of power failure in order to cope with failures, such as a power failure and the like, and to switch/connect a telephone set to a public line when the backup power supply stop supplying power, and with a function to interface a LAN, and to easily cope with failures and disasters. However, even in this case, a special line card is needed to continuously supply power from a backup power supply at the time of the stoppage of a power supply function to supply a telephone set with power and to switch/connect a telephone set to a public line when the backup power supply stops supplying power, which is another problem.

### SUMMARY OF THE INVENTION

It is an object of the present invention to provide a server backup device for enabling the use of the intra-office telephone service for terminals in a service area when an IP Centrex server fails and its function is nullified, in order to solve the above-described problems.

The server backup device of the present invention is installed between a plurality of telephone terminals connected to a network and a server for switching/connecting intra-office communication between terminals on the network or communication between terminals on and outside the network, and backs up the server. The server backup device comprises a server failure detection unit detecting the failure of the server, and a message transfer unit rewriting a destination address in a prescribed message transmitted from a terminal for intra-office communication between terminals on the network from the address of the server backup device to the address of a called terminal during the failure of the server, and directly transferring the message to the called terminal without going through the server.

The sever backup device in another aspect of the present invention comprises the server failure detection unit detecting the failure of the server and a message generation unit generating a message in reply to a prescribed message transmitted from a terminal on the network during the failure of the server, and transmitting the reply message to a transmitting source terminal of the prescribed message.

### BRIEF DESCRIPTION OF THE DRAWINGS

FIG. 1 shows the basic configuration of the server backup device of the present invention;

FIG. 2 shows the configuration of a system adopting the backup device of the present invention;

FIG. 3 explains the respective operations of the server in the system shown in FIG. 2 both at the normal time and at the time of a failure;

FIG. 4 explains the intra-office communication between terminals when the Centrex server operates normally;

FIG. 5 explains the intra-office communication between terminals when the Centrex server fails;

FIG. 6 shows the detailed configuration of the backup device shown in FIG. 2;

FIG. 7 shows an example of the stored contents of an active call table;

FIG. 8 shows am example of the stored contents of an end point table;

FIG. 9 is a specific example of a register message;

FIG. 10 shows a specific example of message rewriting when the Centrex server normally operates (No. 1);

FIG. 11 shows a specific example of message rewriting when the Centrex server normally operates (No. 2);

FIG. 12 shows a specific example of message rewriting when the Centrex server fails;

FIG. 13 explains the message transfer sequence of an invite message when the Centrex server normally operates;

FIG. 14 explains the message transfer sequence of an invite message when the Centrex server fails; and

FIG. 15 explains the message transfer sequence of a register message when the Centrex server fails.

### DESCRIPTION OF THE PREFERRED EMBODIMENTS

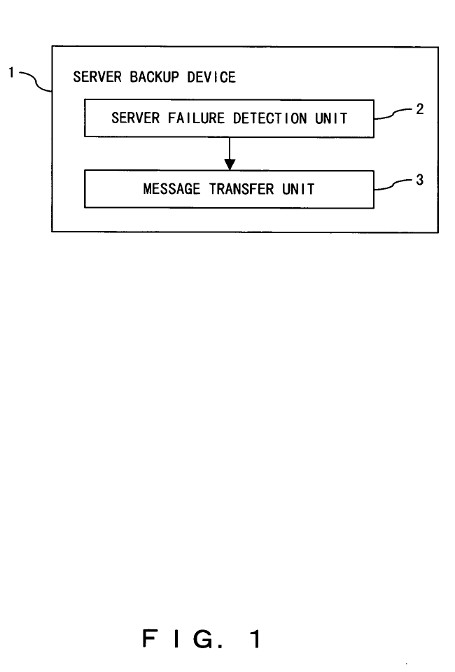

FIG. 1 shows the basic configuration of the server backup device of the present invention. FIG. 1 shows the basic configuration of a server backup device that is installed between a plurality of telephone terminals such as an IP telephone terminal and the like, connected to a network, and a server for switching/connecting the intra-office communication between terminals on the network or communication between terminals on and outside the network, and backs up the server. The server backup device 1 comprises at least a server failure detection unit 2 and a message transfer unit 3.

The server failure detection unit 2 detects the failure of the server, and, for example, corresponds to the combination of a call status management unit and an SIP message reading unit, which are described later. The message transfer unit 3 rewrites a destination address in a prescribed message transmitted from a terminal for intra-office communication on the network from the address of the server backup device to the address of a called terminal, and directly transferring the message to the called terminal without going through the server. It corresponds, for example, to an SIP message rewriting unit.

In a preferred embodiment, the backup device 1 can further comprise an end point storage unit storing the end point name and IP address of each terminal as its identifiers, corresponding to each of a plurality of IP telephone terminals, such as an end point table, and the message transfer unit 3 can transfer message, based on the stored contents of the end point storage unit. In this case, the prescribed message can also be an invite message transmitted to request a called terminal to establish a call.

Another server backup device of the present invention comprises the server failure detection unit and a message generation unit generating a response message in correspondence with a prescribed message transmitted from a terminal on the network during the failure of the server, and transmitting the response message to a transmitting source terminal of the prescribed message, such as an SIP message generation unit. In this preferred embodiment, the prescribed message can also be a register message transmitted from a terminal to register the terminal.

In a preferred embodiment, the server backup device can further comprise a prescribed message receiving times storage unit storing the receiving times of the prescribed messages from the same terminal, such as an active call table, and the server failure detection unit can detect the failure of the server when the stored receiving times of messages exceeds a predetermined value.

As a method for backing up a server which switches/connects intra-office communication between a plurality of telephone terminals connected to a network and communication between terminals on and outside the network, a method for detecting the failure of the server by monitoring the receiving times of a prescribed message from the same terminal, rewriting a destination address in the prescribed message transmitted from a terminal for intra-office communication between terminals on the network from the address of the relevant device to the address of a called terminal during the failure of the server, and directly transferring the message to the called terminal without going through the server, is used.

As a method for backing up a server which switches/connects intra-office communication between a plurality of telephone terminals connected to a network and communication between terminals on and outside the network, a method for detecting the failure of the server by monitoring the receiving times of a prescribed message from the same terminal, generating a message in reply to a prescribed message transmitted from a terminal for intra-office communication between terminals on the network during the failure of the server, and directly transmitting the reply message to a transmitting source terminal.

As described above, according to the present invention, even when a server switching/connecting intra-office communication and external communication and vice versa, fails, the backup device rewrites a transfer destination address in a prescribed message or generates a reply message to a transmitting source terminal.

According to the present invention, when an IP Centrex server fails, intra-office communication between terminals in a service area can be available with no PSTN connection. Thus, a user can conduct intra-office communication without bearing an extra charge, which greatly contributes to improve the practicability of an IP telephone system.

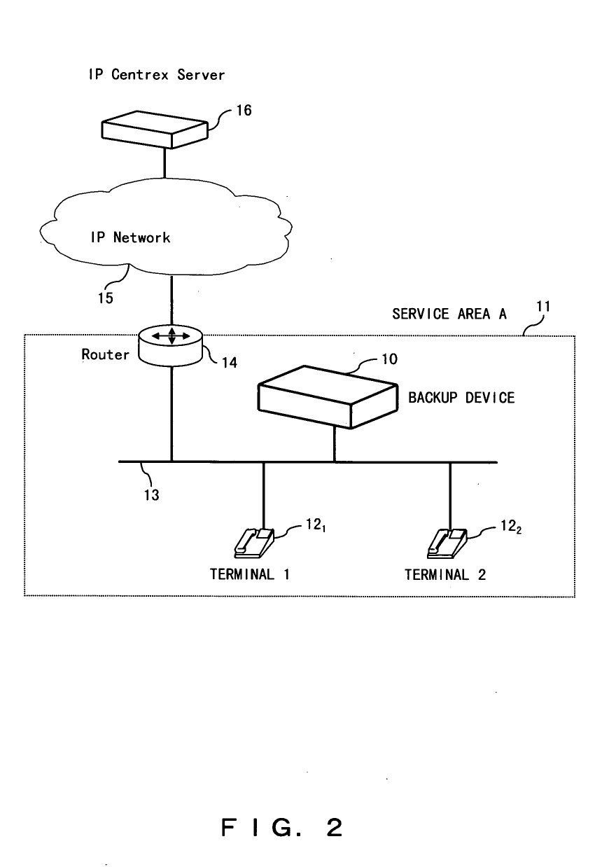

FIG. 2 shows the configuration of a system including the backup device of the present invention, here, a backup device makes the backup when an IP Centrex server fails. In FIG. 2, the backup device 10 of the present invention terminates all IP telephone terminals 12₁, 12₂, etc., in one service area 11, such as A, through a network, such as a local area network (LAN) 13. This network 13 is connected to an IP Centrex server 16 through both a router 14 and an IP network 15. In this case, a telephone terminal 12 in the service area can communicate with the outside of the service area through the router 14 and IP Centrex server 16.

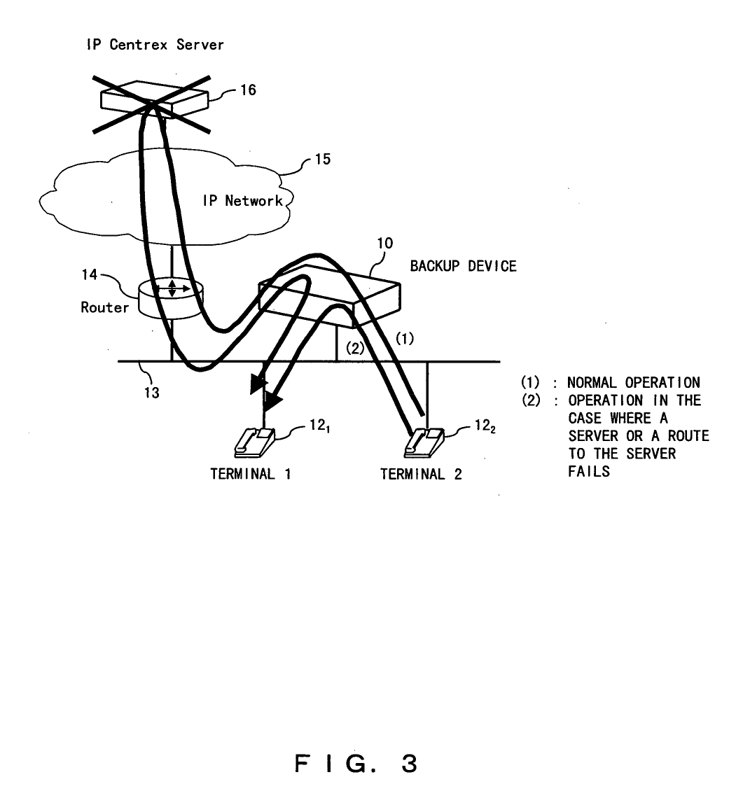

FIG. 3 explains the respective operations of the system shown in FIG. 2, both when the server operates normally and when the server fails. When the server operates normally, a call, for example, from terminal 12₂ to terminal 12₁ reaches the IP Centrex server 16 through the backup device 10, router 14 and IP network 15, and is connected to terminal 12₁ through the IP network 15, router 14 and backup device 10. Thus, communication is available.

However, when the IP Centrex server 16 fails, the backup device 10 detects the failure, and the call from terminal 12₂ is connected through a direct route from the backup device 10 to terminal 12₁.

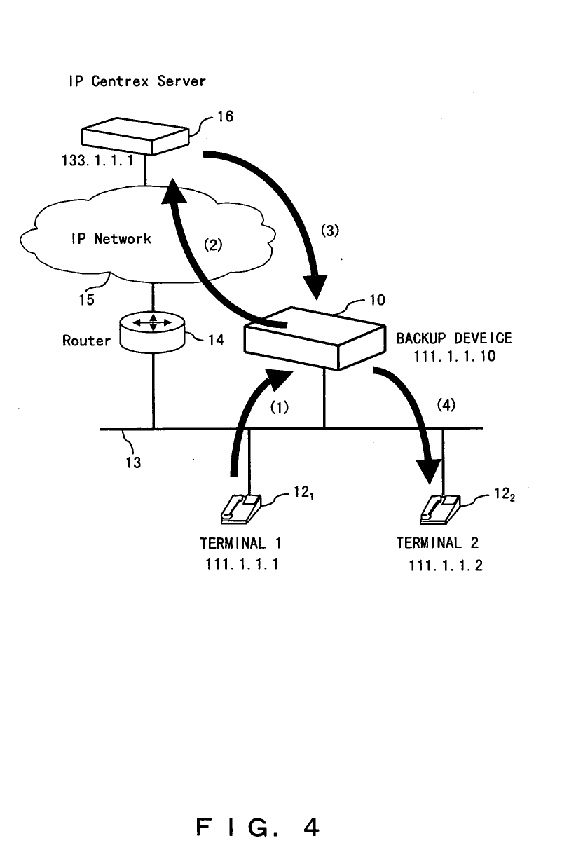

FIG. 4 explains in detail the operation of the system when the Centrex server normally operates. In this example, it is assumed that communication between terminals 12₁ and 12₂ is started by terminal 12₁ originating a call. In this example, it is also assumed that the IP addresses of the backup device 10, terminals 12₁ and 12₂, IP Centrex server 16 are 111.1.1.10, 111.1.1.1, 111.1.1.2 and 133.1.1.1, respectively.

In FIG. 4, a session initiation protocol (SIP) message, such as a register message, an invite message and the like, that is transmitted from terminal 12₁ and is used to establish, maintain and terminate a session, reaches the backup device 10 through the LAN 13 in (1), is transferred from the backup device 10 to the IP Centrex server 16 through the LAN 13, router 14 and IP network 15 in (2), then is transferred from the IP Centrex server 16 to the backup device 10 through the IP network 15, router 14 and LAN 13 in (3), and is further transferred from the backup device 10 to terminal 12₂ through the LAN 13 in (4). Actual audio signals after the establishment of a call is completed between terminals, that is, a media stream by a real-time transport protocol (RTP) is directly transmitted/received between the terminals through the LAN 13 without going through the backup device 10. When the IP Centrex server 16 normally operates, actual audio signals are also similarly transmitted/received between terminals.

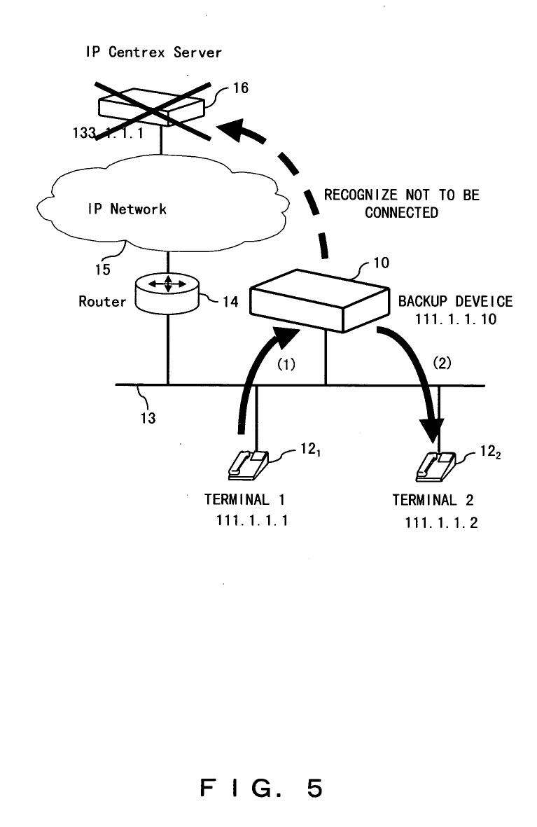

FIG. 5 explains in detail the operation of the system when the Centrex server fails. Same as in FIG. 4, when a message to originate a call, for example, an invite message is transferred from terminal 12₁ to the backup device 10 through the LAN 13 in (1), the backup device 10 has already detected the failure of the IP Centrex server 16, which is described later. Therefore, the backup device 10 directly transfers the invite message to a called IP telephone terminal 12₂ without going through the IP Centrex server 16 in (2), and as a result, communication between the two terminals is made available. The transmission/reception of actual audio signals, that is, of a media stream by a real-time transport protocol after the establishment of the call between the terminals is completed, is directly conducted between the terminals through the LAN 13 without going through the backup device 10. When the IP Centrex server 16 normally operates, actual audio signals are also directly transmitted/received between the terminals.

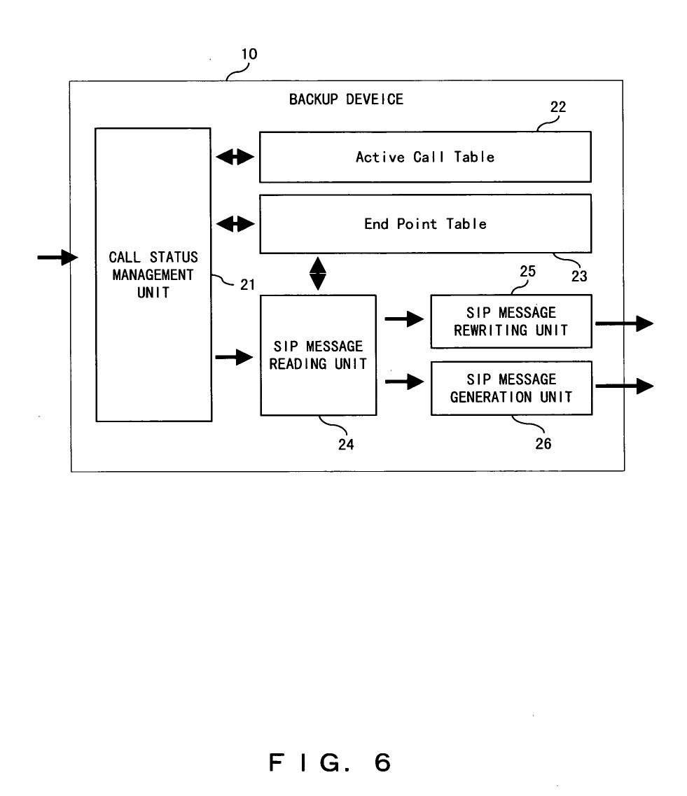

FIG. 6 shows the detailed configuration of the backup device shown in FIG. 2. In FIG. 6, the backup device 10 comprises a call status management unit 21, an active call table 22, an end point table 23, an SIP message reading unit 24, an SIP message rewriting unit 25 and an SIP message generation unit 26.

In FIG. 6, all SIP messages to be inputted to the backup device 10 are firstly supplied to the call status management unit 21, the type of each message is discriminated, the handling of each message is determined and the call status is managed. The active call table 22 stores information about a call in current communication, and the call status management unit 21 determines the handling of each SIP message, based on the information. The end point table 23 stores information about each IP telephone terminal in the service area. In this case, an end point generally means the source or sink of data that is physically or logically exists in an entity.

Corresponding to the input of an SIP message through the call status management unit 21, The SIP message reading unit 24 determines whether the transmitting destination of the SIP message exists or whether the message can be transferred to the transmitting destination, based on the stored contents of the endpoint table 23 or the like. If the transmitting destination exists and the message can be transferred, the SIP message reading unit 24 outputs the message to the SIP message rewriting unit 25. If the transmitting destination does not exist or if, for example, the IP Centrex server 16 fails and the message cannot be transferred to the transmitting destination that exists outside the service area, the unit 24, for example, instructs the SIP message generation unit 26 to generate a new SIP message to respond to the transmitting source of the message.

The call status management unit 21 shown in FIG. 6 classifies all inputted SIP messages into the following four types. The first type is an SIP message related to the establishment of a call transmitted from an IP telephone terminal, such as a register message requesting the IP Centrex server 16 to register the relevant terminal, the second type is an SIP message related to the establishment of a call transmitted from the IP Centrex server 16, the third type is an SIP message related to the termination of a call, such as 200 OK message in reply to a session release request BYE, an error message, an ACK message in reply to 4xx etc., and the fourth type is all SIP messages other than the above-described three types.

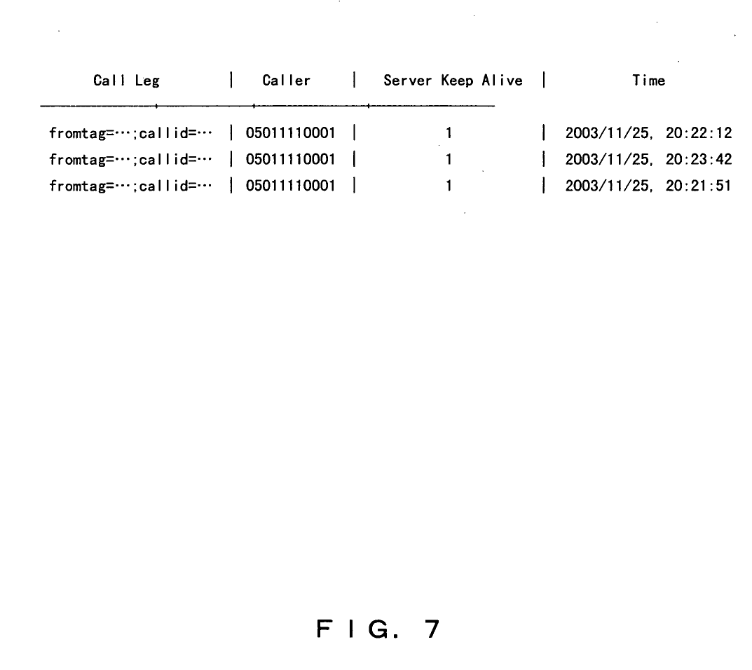

The call status management unit 21 generates a new entry, updates data, deletes an entry and the like in the active call table 22 according to the classified result of each SIP message. FIG. 7 shows an example of the stored contents of an active call table 22. This active call table 22 stores data about a call in current communication. The call status management unit 21 generates one entry for each call in the active call table 22. For example, when a call is transferred, the call in communication and a held call that both exists before transfer are handled separately, and a different entry is generated.

“Call Leg” is data as an identifier used to discriminate a call. “Call Leg” indicates the value of the tag of a From-header in a message, which is described later, and the value of a “Call-ID”, and “Caller” indicates a caller, that is, the phone number of an originating terminal. The value of “Server Keep Alive” corresponds to the times of the consecutive reception of the same message from the originating terminal, and “Time” indicates a time when the latest message of the call is transmitted. This “Time” is used to delete data about the call from the active call table 22 when SIP message related to the call has not been transmitted for a predetermined time.

In this preferred embodiment, for example, it is assumed that whether the IP Centrex server 16 fails in FIG. 2, is determined by the transmitting times of the same SIP message from the same terminal to the backup device 10. The backup device 10 transfers, for example, a register message transmitted by, for example, terminal 12₁ to the IP Centrex server 16 as described above. However, if terminal 12₁ does not receive a reply to the message from the IP Centrex server 16, terminal 12₁ re-transmits the register message.

Therefore, when receiving no reply from the IP Centrex server 16, terminal 12₁ repeatedly transmits, for example, a register message to the backup device 10, and the times of repetition is reflected in the value of the “server keep alive” shown in FIG. 7. If the value exceeds five, that is, if, for example, there is no reply although a register message is transferred to the IP Centrex server 16 five times, the SIP message reading unit 24 determines that the IP Centrex server 16 fails and supplies, for example, both a code 200 OK and the value of a register message transmitting source address to the SIP message generation unit 26 in correspondence with the sixth register message from terminal 12₁. The SIP message generation unit 26 transmits the 200 OK message being a reply to a register message to the transmitting source of the register message. Simultaneously, the backup device 10 directly transfers a message for a subsequent call control from, for example, the same calling terminal to a called IP telephone terminal, for example, 12₂ in the service area without going through the IP Centrex server 16.

In this preferred embodiment, it is assumed that for the SIP message, by the times of whose repeated transmission from the same terminal the failure of the IP Centrex server 16 is detected, an invite message for requesting a called terminal to establish a call (session) is used in addition to the above-described register message.

Such a message is generally called an initial invite message. The invite message includes a re-invite message used when transferring a call, in addition to the initial invite message. In this preferred embodiment, it is assumed that an entry is generated in the active call table 22 in correspondence with each of the register message and initial invite message, and the initial invite message is hereinafter called simply an invite message.

Although the recommendations of a request for contents (RFC) as TCP/IP standards specifies that an IP telephone terminal should re-transmit an SIP message, for example, seven or more times, in this preferred embodiment, it is determined that the IP Centrex server 16 fails when the same SIP messaged is received six times.

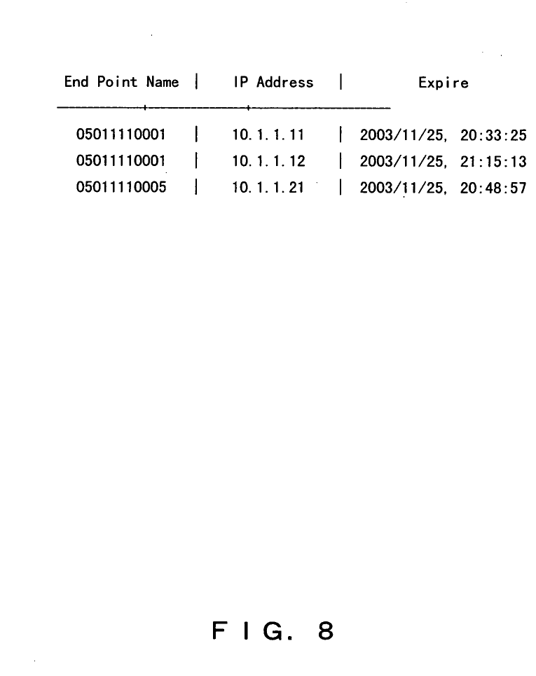

FIG. 8 shows an example of the stored contents of an end point table 23. In FIG. 2, this end point table 23 exists in the service area A, and stores data about each IP telephone terminal that can receive the message. An “End Point Name” and “IP Address”, and an “Expire” indicate the user part of an SIP URI set for each IP telephone terminal, the address of an IP telephone terminal and the validity of the data of the entry, respectively. The call status management unit 21 manages these segments of data. The end point table 23 is also used when transmitting an SIP message to an IP telephone terminal, and the SIP message reading unit 24 sets the transmitting destination of an SIP message, based on the stored contents of the end point table 23.

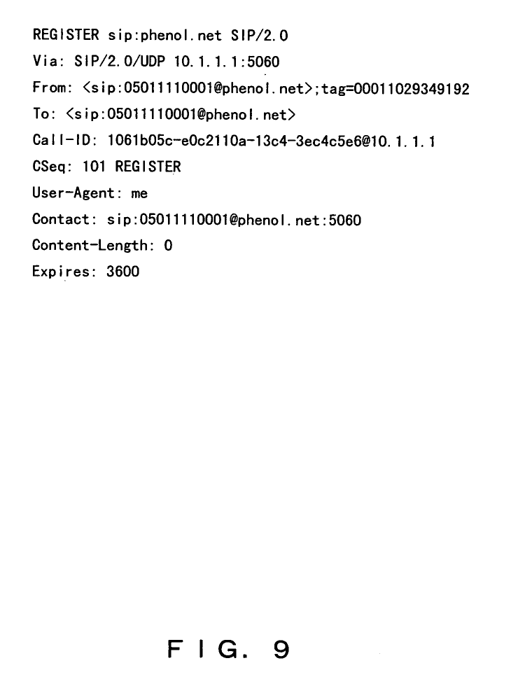

Next, the operations of the call status management unit 21, SIP message reading unit 24 and the like are further described in more detail using an examples of a specific message. FIG. 9 is a specific example of a register message, which is an SIP message used when a terminal registers its IP address in the IP Centrex server.

For the determination as to whether the message as shown in FIG. 9 should be transferred to the IP Centrex server 16 or be directly transferred to a terminal in the service area, the value of “Server Keep Alive” in the active call table 22 as described above is used. Every time the same SIP message is repeatedly received from the same terminal, the call status management unit 21 increments the value of “Server Keep Alive”, and supplies the value and the message to the SIP message reading unit 24. The SIP reading unit 24 determines whether to transfer the message to the IP Centrex server 16 or a terminal based on the value. Since such a message also includes information about a terminal, the call status management unit 21 extracts data indicating two segments of information, that is, an “End Point Name” and an “IP Address”, and reflects these data in the end point table 23 together with the received time of the message.

Next, the operation of the call status management unit 21 is further described in more detail in connection with each of the above-described four types of messages. Firstly, the operation of the call status management unit 21 in connection with an IP message related to the establishment of a call transmitted from a terminal, such as the register message shown in FIG. 9 is as follows.

(1) The “Caller” value is extracted from an SIP message as information for the active call table 22. The user part of the SIP URI of a From-header is read as “Caller”. In the case of FIG. 9, it becomes 05011110001.

(2) Both “From-tag” and “Call-ID” are read from the SIP message as “Call Leg” for the active call table 22. In the case of FIG. 9, “Call Leg”=00011029349192; 1061b05c-e0c2110a-13c4-3ec4c5e6@10.1.1.1.

(3) “Call Leg” is retrieved from the active call table 22, and a “Server Keep Alive” value is read.

(4) When no “Call Leg” exists in the active call table 22, a “Server Keep Alive” value is read as 0 and both “Call Leg” and “Caller” are registered in the active call table 22.

(5) A “Server Keep Alive” value is incremented and its contents are reflected in the active call table 22.

(6) “End Point Name” is retrieved from the end point table 23, and if it exists, both “IP Address” and “Expire” values are overwritten.

(7) If no “End Point Name” exists in the end point table 23, “End Point Name”, “IP Address” and “Expire” values are added.

(8) Two hours are added to the current time, which is registered as the “Expire” value of the end point table 23.

(9) A transmitting source address, a “Server Keep Alive” value and an SIP message are transferred to the SIP message reading unit 24.

Next, the handling of an SIP message related to the establishment of a call transmitted from the IP Centrex server 16, being the second type, is described. In this case, the call status management unit 21 registers data about this call, being a new call to the active call table 22, in a new entry, and both “Server Keep Alive” value and SIP message are transferred to the SIP message reading unit 24. This operation is as follows.

(1) A “Caller” value is extracted from the SIP message, as information for the active call table 22. The user part of the SIP URI of a From-header is read as “Caller”.

(2) Both “From-tag” and “Call-ID” are read from the SIP message as “Call Leg” for the active call table 22.

(3) “Call Leg”, “Caller” and “Server Keep Alive” values are registered in the active call table 22. In this case, the “Server Keep Alive” value is made 0.

(4) A transmitting source address, a “Server Keep Alive” value and the SIP message are transferred to the SIP message reading unit 24.

Next, when an SIP message related to the termination of a call, being the third type, is inputted, the call status management unit 21 transfers both a “Server Keep Alive” value of the call and the SIP message to the SIP message reading unit 24, and then deletes an entry in which data about the call is stored from the active call table 22. This operation is as follows.

(1) A transmitting source address is read from the IP part of a packet.

(2) A “Caller” value is extracted from an SIP message as information for the active call table 22. The user part of the SIP URI of a From-header is read as “Caller”.

(3) Both “From-tag” ad “Call-ID” are read from the SIP message as “Call Leg” for the active call table 22.

(4) “Call Leg” is retrieved from the active call table 22, and a “Server Keep Alive” value. If no “Call Leg” exists, for example, due to an error, the “Server Keep Alive” value is read as 0.

(5) A transmitting source address, the “Server Keep Alive” value and the SIP message are transferred to the SIP message reading unit 24.

(6) If call information is stored in the active call table 22, the call information is deleted from the active call table 22.

Lastly, the operation of the call status management unit 21 in connection with a general SIP message neither related to the establishment nor termination of a call, being the fourth type, is only to transfer both a “Server Keep Alive” value of the call and the SIP message to the SIP message reading unit 24. The operation is as follows.

(1) A transmitting source address is read from the IP part of a packet.

(2) A “Caller” value is extracted from the SIP message as information for the active call table 22. The user part of the SIP URI of a From-header is read as “Caller”.

(3) Both “From-tag” and “Call-ID” are read from the SIP message as “Call Leg” for the active call table 22.

(4) “Call Leg” is retrieved from the active call table 22, and a “Server Keep Alive” value is read. If no “Call Leg” exists, a “Server Keep Alive” value is read as 0.

(5) A transmitting source address, a “Server Keep Alive” value and the SIP message are transferred to the SIP message reading unit 24.

Next, the operation of the SIP message reading unit 24 is further described. The SIP message reading unit 24 receives both the “Server Keep Alive” value of the relevant call and the SIP message as well as the transmitting source address in a message from the call status management unit 21. Then, firstly, the SIP message reading unit 24 determines whether the transmitting source of the SIP message is the IP Centrex server 16 or an IP telephone terminal based on the transmitting source address, and executes the process according to the determined result. It is assumed that the IP address of the IP Centrex server 16 is known as described with reference to FIG. 4.

When a message is received from the IP Centrex server 16, the SIP message reading unit 24 firstly determines whether the type of the relevant SIP message is a “Request” message or a “Response” message. A “Request” message is transmitted when a terminal starts a new operation, an “INVITE” message for requesting for the establishment of a call is an example of this message. A “Response” message is transmitted by a terminal that has received the “Request” message when the terminal responds to this “Request” message.

In the case of a “Request” message, the SIP message reading unit 24 refers to the user part of a request URI, which is described later, in an SIP message, and compares the value with an “End Point Name” value stored in the end point table 23. If an end point name whose value coincides with that of the request URI, exits, the unit 24 reads an IP address from the relevant entry of the end point table 23 as a transmitting destination address, and transfers the transmitting destination address, “Server Keep Alive” value and SIP message to the SIP message rewriting unit 25. And the SIP message rewriting unit 25 rewrites the transmitting destination address in the message from the address of the backup device 10 to the address of a telephone terminal in the service area, and transfers the SIP message transmitted from a terminal in the service area or outside the service area.

If an end point name whose value coincides with that of the request URI, does not exits in the end point table 23, both the IP address of the IP Centrex server 16 as a transmitting destination address and a code 404Not Found indicating that no transfer destination exists as well as the SIP message are transferred from the SIP message reading unit 24 to the SIP message generation unit 26. Then, a new message indicating that no transfer destination exists is generated and transferred to the IP Centrex server 16.

In the case of a “Response” message, the SIP message reading unit 24 reads an IP address from the second line of a Via-header of the SIP message, and transfers a transmitting destination address, a “Server Keep Alive” value and an SIP message to the SIP message rewriting unit 25. Then, the SIP message rewriting unit 25 rewrites the transmitting destination address in the message from the address of the backup device 10 to the address of a telephone terminal in the service area, and transfers the SIP message transmitted from a terminal in the service area or outside the service area.

A Via-header includes the IP address of a device that has transmitted a “Request” message. In FIG. 9, the IP address is 10.1.1.1. If a request message is transmitted through an SIP proxy server, the SIP proxy server adds one line of a via-header including the IP address of the SIP proxy server, and transfers an SIP message.

When a terminal that has received this “Request” message transmits a “Response” message in reply to it, the IP address of this Via-header is used as the transmitting destination of the “Response” message. When the terminal generates a “Response” message, the Via-header inserted in the “Request” message is described in a “Response” message as is. Therefore, the transmitting destination address of a “Response” message is described in the second line of the Via-header of a “Response” message received by the SIP reading unit 24, and the SIP message reading unit 24 reads the IP address as a transmitting destination address from the second line of the Via-header.

When an SIP message transmitted from an IP telephone terminal other than the IP Centrex server 16 is received, the SIP message reading unit 24 determines whether the message is a register message. If it is a register message and the “Server Keep Alive” value received from the call status management unit 21 exceeds five, the unit 24 sets the value of the transmitting source address transferred from the call status management unit 21 as a transmitting destination address and transfers both the transmitting destination address and a code 200 OK indicating the completion of the registration of an end point as well as an SIP message to the SIP message generation unit 26. Thus, a new message indicating the completion of the registration of an end point is generated and transmitted to the transmitting source terminal in the register message.

If it is a register message and if the “Server Keep Alive” value is five or less, the unit 24 sets the IP address of the IP Centrex server 16 as a transmitting destination address, and transfers the transmitting destination address as well as an SIP message to the SIP message rewriting unit 25. Then, the transmitting destination address in the message is rewritten, and the message is transmitted to the IP Centrex server 16.

When an SIP message other than a register message and an initial invite message from a terminal other than the IP Centrex server 16 is received, the SIP message reading unit 24 firstly determines whether the type of the SIP message is a “Request” message or a “Response” message.

If it is a “Request” message, and if a “Server Keep Alive” value corresponding to the call is six or more, the SIP message reading unit 24 refers to the user part of a request URI in the SIP message, and compares the value with an “End Point Name” value stored in the end point table 23. If they coincide, the unit 24 reads an IP address from the end point table 23, and transfers the value as a transmitting destination address to the SIP message rewriting unit 25 together with the “Server Keep Alive” value and an SIP message.

If the value does not coincide with the “End Point Name” value in the end point table 23, the unit 24 refers to the “Server Keep Alive” value. If the value is six or more, the unit 24 generates, for example, a code 404Not Found indicating the unavailability of communication with the outside, sets the transmitting source address of the SIP message as a transmitting destination address, and transfers the transmitting destination address, code and SIP message to the SIP message generation unit 26. The SIP message generation unit 26 generates a message indicating that the call cannot be connected to a called terminal, and transmits the message to the transmitting source terminal in the SIP message.

If the message is a “Response” message, the SIP message reading unit 24 reads an IP address from the second line of the Via-header of the SIP message and transfers a transmitting destination address, a “Sever Keep Alive” value and an SIP message to the SIP message rewriting unit 25.

If the referred “Server Keep Alive” value is five or less, the SIP message reading unit 24 sets the address of the IP Centrex server 16 as a transmitting destination address, and transfers the transmitting destination address, “Server Keep Alive” value and SIP message to the SIP message rewriting unit 25. The SIP message rewriting unit 25 rewrites the address and transmits the message toward the IP Centrex server 16.

Next, the operation of the SIP message rewriting unit 25 is further described. The SIP message rewriting unit 25 rewrites, for example, the transmitting destination or source addresses in a message, based on the SIP message and transmitting destination address transferred by the SIP message reading unit 24, and transmits the rewritten SIP message, using the transferred transmitting destination address as an address. In this case, the SIP message rewriting unit 25 rewrites the SIP message in such a way the IP address of the relevant device, for example, 111.1.1.10 in FIG. 4, is the transmitting source of the SIP message so that the IP Centrex server 16 or IP telephone terminal recognizes as if the backup device 10 were a transmitting source. For example, in the register message shown in FIG. 9, a session description protocol (SDP) that specifies how to describe session information follows the SID message. However, this SDP part is not rewritten.

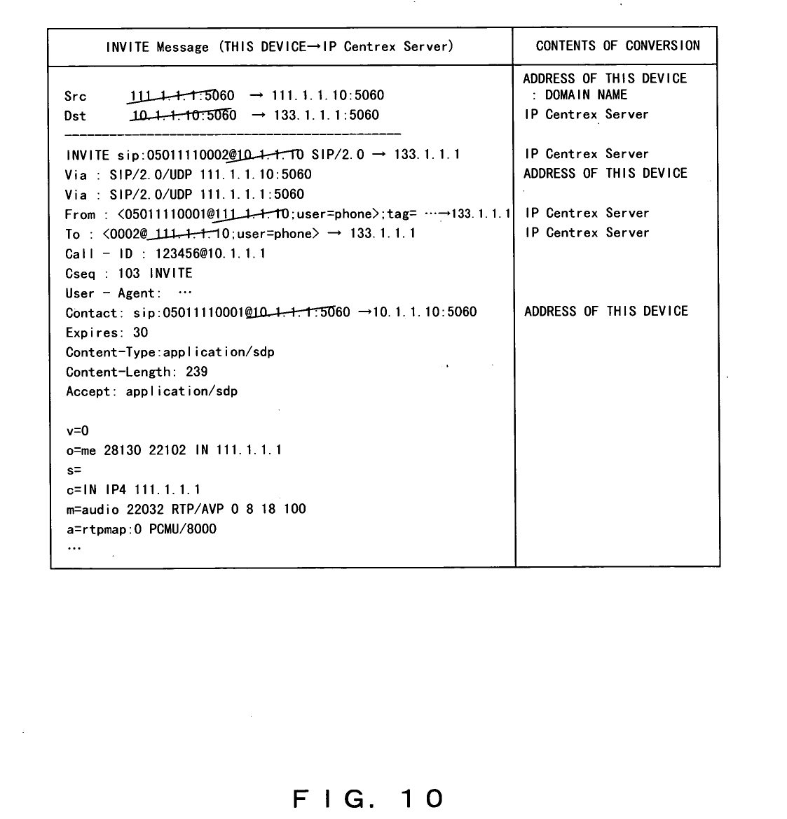

FIGS. 10 through 12 shows the specific examples of message rewriting by the SIP message rewriting unit 25. FIG. 10 shows an example of the rewriting of an invite message transmitted from the backup device 10 to the IP Centrex server 16 when the IP Centrex server 16 normally operates.

In FIG. 10, firstly, the leading transmitting source address (Src) is rewritten into both the address of the backup device 10 and a domain name, and a transmitting destination address (Dst) is rewritten into the IP address of the IP Centrex server 16. Then the request URI (10.1.1.10) on the first line of an invite message is rewritten into the IP address of the IP Centrex server 16. As to a Via-header, one line indicating the IP address of the backup device 10 is added to it. The respective host parts of a From-header and a To-header are rewritten into the IP address of the IP Centrex server 16, and the host part of Contact-header is further rewritten into the IP address of the backup device 10. In this case, one line is added to the Via-header in order to facilitate the process when receiving a “Response” message, and the added Via-header is, for example, deleted when receiving this “Response” message.

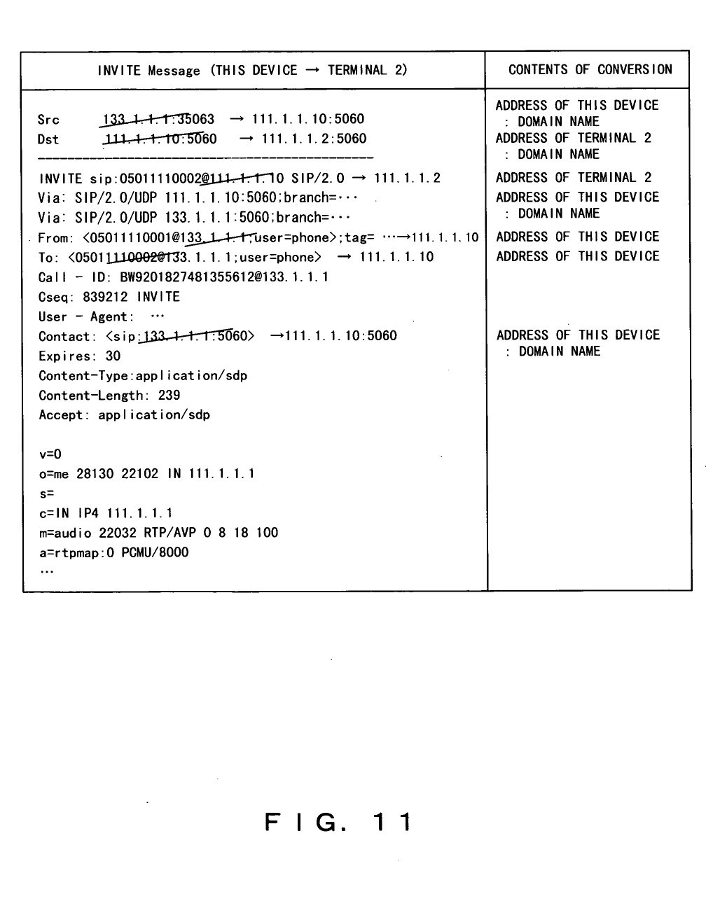

FIG. 11 shows a specific example of rewriting in the case where a Centrex server normally operates. In FIG. 11, a specific example of the rewriting of an invite message transmitted from the IP Centrex server 16 to an IP telephone terminal in the service area. Specifically, its source address is rewritten from the IP address of the IP Centrex server 16 to the address of the backup device 10, and the destination address is rewritten from the address of the backup device 10 into the address of telephone terminal 12₂. Similarly, the request URI is rewritten into the address of telephone terminal 12₂, and the IP address of the backup device 10 is used on and after the first line of the Via-header.

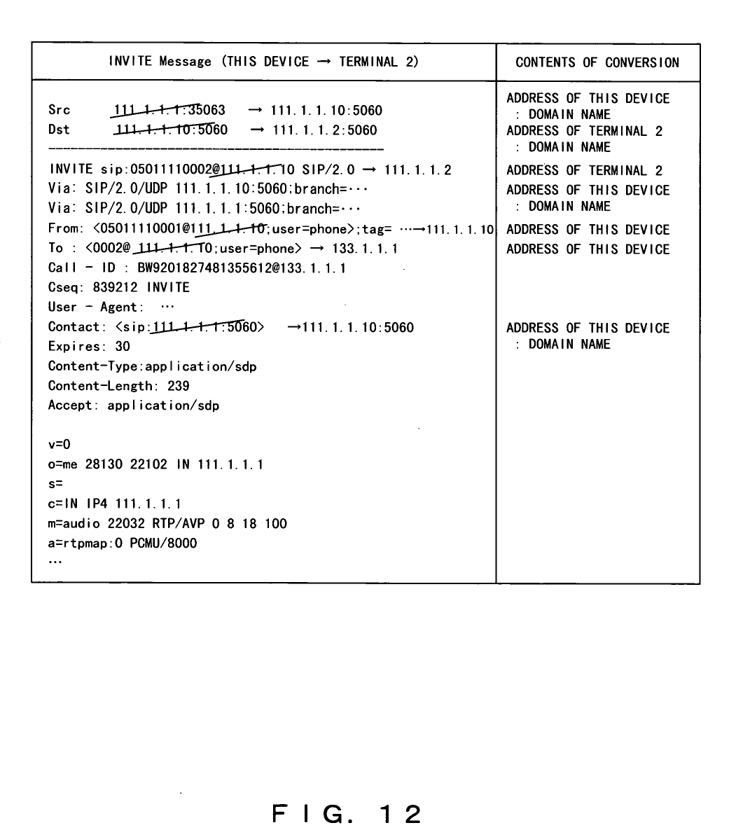

FIG. 12 shows an example of the rewriting of an invite message transmitted from IP telephone terminal 12₁ when the Centrex server 16 fails, and the result is the same as that of the rewriting shown in FIG. 11 where the IP Centrex server normally operates. Therefore, the IP telephone terminal 12₂ that has received this message can receive an invite message from another terminal in the service area without being aware of the failure of the IP Centrex server 16.

Next, the operation of the SIP message generation unit 26 shown in FIG. 6 is further described. The SIP message generation unit 26 receives both the transmitting destination address of the message and an SIP code to be stored in a new message as well as the SIP message from the SIP message reading unit 24, generates a new SIP message using these segments of data and transmits the message to the transmitting destination address. Thus, if no transmitting destination of the SIP message inputted from outside the service area through the IP Centrex server 16 exists as described above, a new message storing a code indicating the fact is generated and is transmitted to the IP Centrex server 16. If the IP Centrex server fails and the IP Centrex server 16 does not respond to, for example, five or more times of consecutive transmission of a register message from the same terminal, a new message is generated indicating the registration of an end point corresponding to the register message is made and is transmitted to the IP telephone terminal which is the transmitting source of the register message.

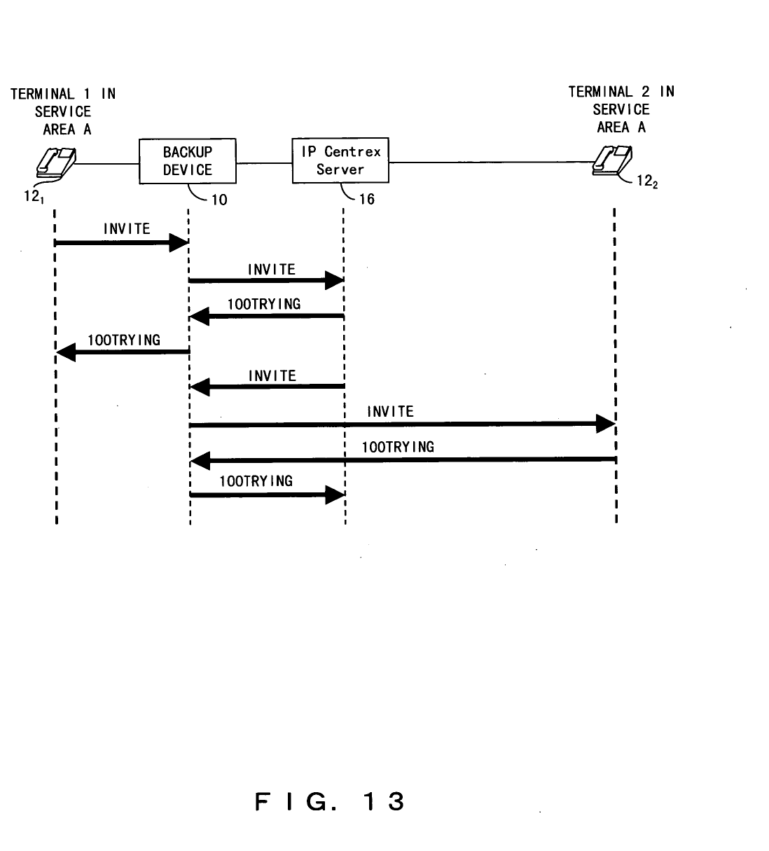

Lastly, the transfer sequence of a message in this preferred embodiment is described with reference to FIGS. 13 through 15. FIG. 13 shows the message transfer sequence of an invite message in the case where a Centrex server normally operates. In FIG. 13, if an invite message requesting for the start of a new session is transmitted from terminal 12₁ to the IP Centrex server 16 through the backup device 10, a 100 Trying message is transmitted from the IP Centrex server 16 to the backup device 10 in reply to the message and is further transmitted from the backup device 10 to terminal 12₁. And, an invite message is transmitted from the IP Centrex server 16 to the backup device 10. In reply to this invite message, the backup device 10 transmits an invite message to terminal 12₂. In reply to this invite message, a 100 Trying message is transmitted from terminal 12₂ to the backup device 10, and is further transmitted from the backup device 10 to the IP Centrex server 16 to normally start a new session.

However, in order to transfer the SIP message to an IP telephone terminal, data about the telephone terminal is needed. This data can be obtained from the contents of a register message transmitted to the IP Centrex server 16 when the power of the IP telephone terminal is switched on or the contents of the invite message is transmitted to start a call, and the data about the terminal is registered in the end point table 23 as described earlier.

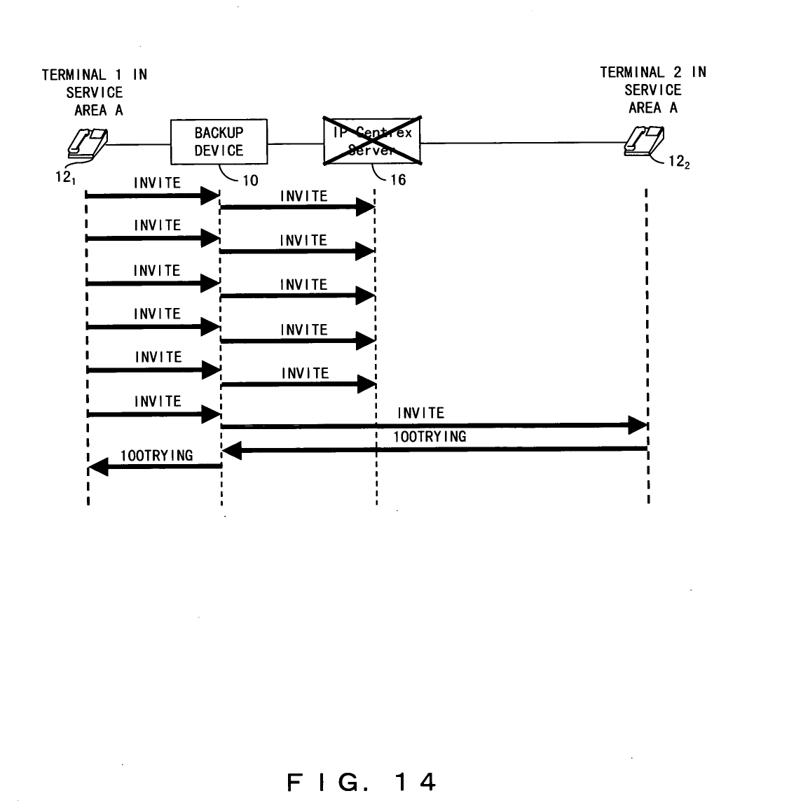

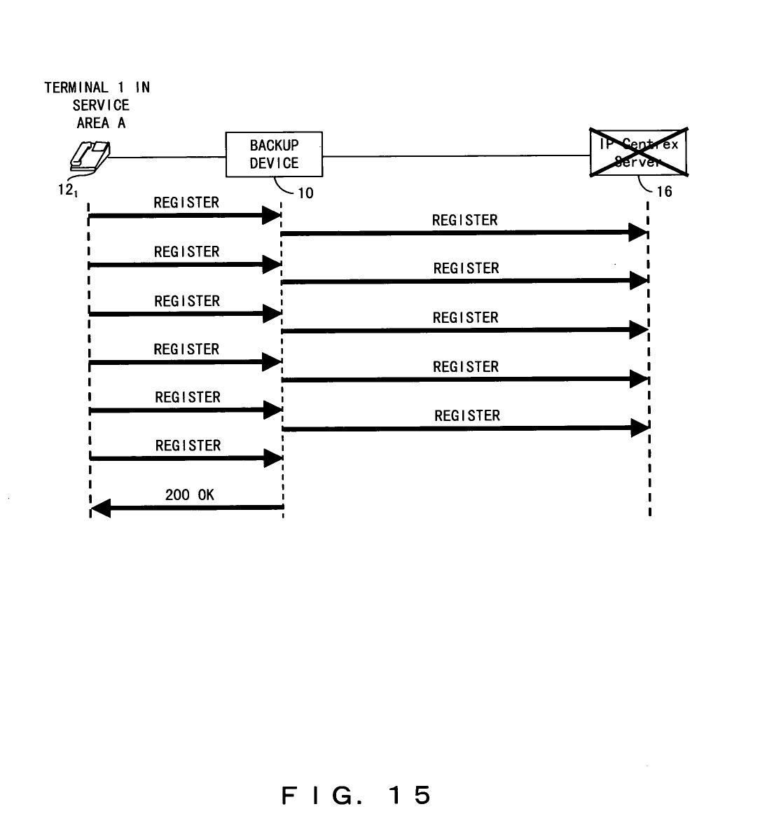

FIGS. 14 and 15 shows the transfer sequence of the SIP message in the case where the IP Centrex server 16 fails. FIG. 14 shows the transfer sequence of an (initial) invite message for a session. In this preferred embodiment, as described earlier, not only a register message but also an invite message for a session are transmitted five or more times consecutively to the Centrex server, in this case, if there is no reply from the Centrex server, the backup device 10 determines that the IP Centrex server 16 fails and directly transmits the message transmitted by terminal 12₁ to a called terminal 12₂.

Specifically, in FIG. 14, an invite message is transferred to the IP Centrex server 16 through the backup device 10 five times consecutively and if there is no reply from the IP Centrex server 16, in correspondence with the sixth invite message, the backup device 10 directly transmits an invite message to a called terminal 12₂, and the terminal 12₂ transmits a 100 TRYING message to terminal 12₁ through the backup device 10 in reply to the message to start a session.

As to this call, since data about the call is stored in the active call table 22 shown in FIG. 6, SIP messages other than invite and register messages are directly transferred between terminals 12₁ and 12₂ without going through the IP Centrex server 16.

FIG. 15 shows the transfer sequence of a register message. In FIG. 15, since there has been no reply even though a register message had been transmitted to terminal 12₁ from the IP Centrex server 16 five times, the backup device 10 generates a message with a code 200 OK indicating the completion of the registration of an end point, and transmits the message to terminal 12₁ in correspondence with the sixth register message. By doing so, terminal 12₁ can recognize that communication between terminals in the service area is available after then.

Generally, an IP telephone terminal has a function to regularly transmit this register message. For example, its transmitting interval is specified to be 3,600 seconds. If this register message is not normally processed, some terminals cannot operate. If the IP Centrex server 16 fails, the operation of an IP telephone terminal is ensured by the backup device 10 generating a new SIP message with a code 200 OK and responding to the IP telephone terminal.

1. A server backup device which is installed between a plurality of telephone terminals connected to a network and a server for switching/connecting intra-office communication between terminals on the network or communication between terminals on and outside the network, and backs up the server, comprising:
a server failure detection unit detecting a failure of the server; and
a message transfer unit rewriting a destination address in a prescribed message transmitted from a terminal for intra-office communication between terminals on the network from an address of the server backup device to an address of a called terminal during the failure, and directly transferring the message to the called terminal without going through the server.

2. The server backup device according to claim 1, further comprising
an end point storage unit storing both a name of an endpoint as an identifier of a terminal and an address of the terminal, corresponding to each of the plurality of telephone terminals, wherein
said message transfer unit transfers a message based on the stored contents of said end point storage unit.

3. The server backup device according to claim 1, wherein
said prescribed message is an invite message transmitted from the terminal to a called terminal to require for establishment of a call.

4. A server backup device which is installed between a plurality of telephone terminals connected to a network and a server for switching/connecting intra-office communication between terminals on the network or communication between terminals on and outside the network, and backs up the server, comprising:
a server failure detection unit detecting a failure of the server; and
a message generation unit generating a response message in correspondence with a prescribed message transmitted from a terminal on the network during the failure and transmitting the response message to a transmitting source terminal of the prescribed message.

5. The server backup device according to claim 4, wherein
said prescribed message is a register message transmitted from a terminal to register the terminal.

6. The server backup device according to claim 1, further comprising
a prescribed message receiving times storage unit storing receiving times of the prescribed message from the same terminal; wherein
when the stored receiving times of the message exceeds a predetermined value, said server failure detection unit detects a failure of the server.

7. The server backup device according to claim 4, further comprising
a prescribed message receiving times storage unit storing receiving times of the prescribed message from the same terminal; wherein
when the stored receiving times of the message exceeds a predetermined value, said server failure detection unit detects a failure of the server.

8. A method for backing up a server which switches/connects intra-office communication between a plurality of telephone terminals connected to a network and communication between terminals on and outside the network, comprising:
monitoring times of receiving a prescribed message from the same terminal and detecting a failure of the server; and
rewriting a destination address in the prescribed message transmitted from the terminal for intra-office communication between terminals on the network from an address of the relevant device to an address of a called terminal during a failure of the server, and directly transferring the message to the called terminal without going through the server..

9. A method for backing up a server which switches/connects intra-office communication between a plurality of telephone terminals connected to a network and communication between terminals on and outside the network, comprising:
monitoring times of receiving a prescribed message from the same terminal and detecting a failure of the server; and
generating a response message in correspondence with a prescribed message transmitted from a terminal on the network during a failure of the server, and transmitting the response message to a transmitting source terminal of the prescribed message.

10. A server backup device which is installed between a plurality of telephone terminals connected to a network and a server for switching/connecting intra-office communication between terminals on the network or communication between terminals on and outside the network, and backs up the server, comprising:
server failure detection means for detecting a failure of the server; and
message transfer means for rewriting a destination address in a prescribed message transmitted from a terminal for intra-office communication between terminals on the network from an address of the server backup device to an address of a called terminal during the failure, and directly transferring the message to the called terminal without going through the server.

11. A server backup device which is installed between a plurality of telephone terminals connected to a network and a server for switching/connecting intra-office communication between terminals on the network or communication between terminals on and outside the network, and backs up the server, comprising:
server failure detection means for detecting a failure of the server; and
message generation means for generating a response message in correspondence with a prescribed message transmitted from a terminal on the network during the failure and transmitting the response message to a transmitting source terminal of the prescribed message.
